(19) United States
(12) Patent Application Publication
(10) Pub. No.: US 2025/0197029 A1
(43) Pub. Date: Jun. 19, 2025

(54) DEPLOYMENT SYSTEM

(71) Applicant: Israel Aerospace Industries Ltd., Lod (IL)

(72) Inventor: Asaf KAINAN, Lod (IL)

(21) Appl. No.: 18/848,257

(22) PCT Filed: Mar. 19, 2023
(86) PCT No.: PCT/IL2023/050285

§ 371 Date: Sep. 18, 2024

(30) Foreign Application Priority Data
Mar. 20, 2022 (IL) 291505

(51) Int. Cl. B64G 1/22; B64G 1/44

(52) U.S. Cl. CPC B64G 1/2229; B64G 1/2224; B64G 1/443

(57) ABSTRACT

A deployment system pivotably deploys panel elements between a stowed configuration and a deployed configuration. Actuator(s) associated with each pair of panel elements include a first bracket mountable to one panel element, a second bracket mountable to the other panel element, and a linear motion to rotary motion converter (LMRMC) for pivoting the first bracket with respect to the second bracket responsive to a predetermined datum linear displacement being applied to the LMRMC. An actuation cable, coupled to each actuator, can be displaced linearly with respect thereto between a first position, corresponding to the stowed configuration, and a second position, corresponding to the deployed configuration, responsive to operation of the drive unit, such as to apply at least a corresponding datum linear displacement to the respective LMRMC of each actuator. The drive unit is configured for selectively displacing the actuation cable between the first position and the second position.

### TECHNOLOGICAL FIELD

The presently disclosed subject matter relates to deployment systems for deploying pivotably connected panel elements, in particular solar panels.

### BACKGROUND

Many types of spacecraft, including satellites, are equipped with one or more panel assemblies of solar panels, each panel assembly including a plurality of solar panels. Such spacecraft are typically launched with the panels in a compact state—commonly in a folded state or rolled state—and the panels are deployed once the spacecraft has reached the appropriate flight stage in space.

Many different mechanisms have been provided over the years for deploying such panels.

By way of non-limiting example, U.S. Pat. No. 4,155,524 discloses synchronized angular displacement of articulated elements of an outwardly-extendable solar-cell panel, carried out by means of a device mounted between any two successive panel elements constituting a driving element and a driven element. Two independent and parallel traction members are pivotally mounted on support plates which are rigidly fixed to two successive driving elements. Two link-arms for traction members such as cables are pivotally attached to pins forming anchoring points for the cables. Each support plate has two stationary stops for limiting the angular displacements of the link-arms during the relative pivotal movement of the driven element with respect to the driving element.

Further byway of non-limiting example, U.S. Pat. No. 6,031,178 discloses a panel assembly including a number of rectangular panels each carrying solar cells or a cooling radiator on one of the two main surfaces, where the panels are interconnected mutually by hinges such that the assembly from a first state, in which the panels are folded into a package, can be brought into a second state in which the package is unfolded and the panels are situated alongside each other. A torsion element substantially extends across the other main surface of each panel from a first position on the hinge axis between the panel and the adjoining panel at one side, to a second position on the hinge axis between the panel and the adjoining panel at the other side, whereby the torsion element at or near the first and second positions is attached to the respective adjoining panel.

Further by way of non-limiting example, U.S. Pat. No. 6,008,447 discloses a transmission for folding out the solar cell panels folded in an accordion-like manner on a spacecraft having cable pulleys at the hinges, around pairs of which pulleys endless cables are wound. To adapt its change in length during temperature changes to the change in the length of the panels and to increase its rigidity to elongation, the cable is provided with a plastic sheathing firmly connected to same outside the area of the cable pulleys.

Further by way of non-limiting example, U.S. Pat. No. 4,555,585 discloses a foldable solar cell panel apparatus having at least two panel portions which are connected together at a foldable edge to form at least one foldable pair which, in the folded-together state, is preferably stored in a panel container. A stationary folding and unfolding system brings the solar cell panel into the folded or unfolded state. During the folding process, the lowermost deployed foldable pair is folded together while the foldable pairs above it remain unfolded. The deployed foldable pairs are folded together individually in succession. During the unfolding process, the uppermost foldable pair stored in the panel container is unfolded while the fold pairs below it are held in the folded state. The stored foldable pairs are unfolded in succession during deployment.

Further by way of non-limiting example, EP 0955237 discloses solar energy panels used on satellite system are arranged as a series of folded units that can unfold to provide a continuous projection. The panels are coupled together by tensioned wire loops that pass around pairs of rollers. The wire is produced of a material with a neutral thermal expansion coefficient.

Further by way of non-limiting example, KR 100540978 discloses an unfurling device for solar panels in a satellite.

### General Description

According to a first aspect of the presently disclosed subject matter, there is provided a deployment system for pivotably deploying a first plurality of panel elements between a stowed configuration and a deployed configuration, wherein adjacent pairs of the panel elements are pivotably mounted to one another about a respective panel element pair pivot axis, the deployment system comprising a second plurality of actuators, an actuation cable and a drive unit, wherein:
at least one said actuator is associated with each respective pair of said panel elements, each said actuator comprising a first bracket, a second bracket and a linear motion to rotary motion converter, the first bracket being configured for being fixedly mounted to one panel element of the pair, the second bracket being configured for being fixedly mounted to another panel element of the pair, the respective first bracket and the respective second bracket being pivotably mounted with respect to one another about an actuator pivot axis co-axial with the respective panel element pair pivot axis, and wherein the linear motion to rotary motion converter is configured for pivoting the respective first bracket with respect to the respective second bracket responsive to a predetermined datum linear displacement being applied to the linear motion to rotary motion converter;
the actuation cable being serially coupled to each said actuator of said second plurality of actuators, the actuation cable configured for being displaced linearly with respect to the plurality of actuators at least between a first cable position, corresponding to the stowed configuration, and a second cable position, corresponding to the deployed configuration, responsive to operation of the drive unit, such as to apply a corresponding said datum linear displacement to the respective linear motion to rotary motion converter of each said actuator;
the drive unit being configured for selectively displacing the actuation cable at least between the first cable position and the second cable position.

For example, each respective said linear motion to rotary motion converter comprises a linearly movable shaft element, coupled to the actuation cable. For example, each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element. For example, the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement. For example, the cam groove comprises at least one linear portion, and wherein application of a second axial displacement of the shaft element relative to the second bracket causes the cam follower to follow at least a portion of said linear portion, preventing the cylinder together with the first bracket from pivoting about the respective pivot axis. For example, the cam groove comprises at least one tapering portion smoothly connecting one said linear portion with one end of one said helical portion.

In at least some examples, at least one said linear motion to rotary motion converter can be in the form of a rack and pinion arrangement.

In at least some examples, at least one said respective said linear motion to rotary motion converter is in the form of a slider crank arrangement.

Additionally or alternatively, for example, said pivot angle is between about 900 and about 270°.

Additionally or alternatively, for example, said pivot angle is about 180°.

Additionally or alternatively, for example, all said actuators of said second plurality of actuators are configured for pivoting simultaneously responsive to a predetermined said datum linear displacement being applied to all the respective linear motion to rotary motion converters.

Alternatively, for example, all said actuators of said second plurality of actuators are configured for pivoting at the same pivoting rate responsive to a predetermined said datum linear displacement rate being applied to all the respective linear motion to rotary motion converters.

Alternatively, for example, said actuators of said second plurality of actuators are configured for pivoting non-simultaneously with respect to one another, responsive to a predetermined said datum linear displacement being applied simultaneously to all the respective linear motion to rotary motion converters.

Alternatively, for example, at least some said actuators of said second plurality of actuators are configured for pivoting at respective pivoting rates that are different with respect to one another, responsive to a predetermined said datum linear displacement rate being applied simultaneously to all the respective linear motion to rotary motion converters. Alternatively, for example, said actuators of said second plurality of actuators are configured for pivoting in a synchronized manner with respect to one another responsive to operation of the drive unit and the actuation cable.

Alternatively, for example, the actuation cable is enclosed within an envelope comprising a second plurality of windows, the envelope configured for maintaining a predetermined tension in the actuation cable.

For example, said envelope is provided by a sheath.

For example, said envelope is in the form of an incompressible sheath having a lumen that allows relative axial movement between the actuation cable and the sheath.

For example, the envelope is in the form of a Bowden cable.

For example, the envelope is provided by channels provided in the panel elements.

Additionally or alternatively, for example, each said actuator is operatively coupled to the actuation cable at a respective said window.

Additionally or alternatively, for example, the deployment system further comprises a locking arrangement, coupled to the actuation cable, wherein the locking arrangement is configured for maintaining the plurality of panels elements locked in the stowed configuration at least until the drive unit is activated.

According to the first aspect of the presently disclosed subject matter, there is also provided a deployment system pivotably deploys panel elements between a stowed configuration and a deployed configuration. Actuator(s) associated with each pair of panel elements include a first bracket mountable to one panel element, a second bracket mountable to the other panel element, and a linear motion to rotary motion converter (LMRMC) for pivoting the first bracket with respect to the second bracket responsive to a predetermined datum linear displacement being applied to the LMRMC. An actuation cable, coupled to each actuator, can be displaced linearly with respect thereto between a first position, corresponding to the stowed configuration, and a second position, corresponding to the deployed configuration, responsive to operation of the drive unit, such as to apply at least a corresponding datum linear displacement to the respective LMRMC of each actuator. The drive unit is configured for selectively displacing the actuation cable between the first position and the second position.

According to a second aspect of the presently disclosed subject matter, there is provided a panel system comprising a first plurality of panel elements and a deployment system for pivotably deploying the first plurality of panel elements between a stowed configuration and a deployed configuration, wherein adjacent pairs of the panel elements are pivotably mounted to one another about a respective pivot axis, the deployment system being as defined herein with respect to the first aspect of the presently disclosed subject matter.

For example, said panel elements are in the form of solar panels.

Additionally or alternatively, for example, at least one said panel element is configured for being pivotably mounted to a structure. For example, said structure is a space vehicle.

According to a third aspect of the presently disclosed subject matter, there is provided a space vehicle comprising a panel system as defined herein with respect to the second aspect of the presently disclosed subject matter.

According to a fourth aspect of the presently disclosed subject matter, there is provided an actuator for a deployment system, said actuator comprising a first bracket, a second bracket and a linear motion to rotary motion converter, the first bracket being configured for being fixedly mounted to a panel element, the second bracket being configured for being fixedly mounted to another panel element, the respective first bracket and the respective second bracket being pivotably mounted with respect to one another about an actuator pivot axis co-axial with the respective panel element pair pivot axis, and wherein the linear motion to rotary motion converter is configured for pivoting the respective first bracket with respect to the respective second bracket responsive to a predetermined datum linear displacement being applied to the linear motion to rotary motion converter, and wherein the linear motion to rotary motion converter is configured for being coupled to an actuation cable.

For example, each respective said linear motion to rotary motion converter comprises a linearly movable shaft element, configured for being coupled to the actuation cable.

For example, each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element.

For example, the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement.

For example, the cam groove comprises at least one linear portion, and wherein application of a second axial displacement of the shaft element relative to the second bracket causes the cam follower to follow at least a portion of said linear portion, preventing the cylinder together with the first bracket from pivoting about the respective pivot axis.

For example, the cam groove comprises at least one tapering portion smoothly connecting one said linear portion with one end of one said helical portion.

According to a fifth aspect of the presently disclosed subject matter, there is provided a method for deploying a panel system comprising
providing a first plurality of panel elements and a deployment system for pivotably deploying the first plurality of panel elements between a stowed configuration and a deployed configuration, wherein adjacent pairs of the panel elements are pivotably mounted to one another about a respective pivot axis, the deployment system being as defined herein regarding the first aspect of the presently disclosed subject matter;
operating the deployment system to cause the panel system to transition the first plurality of panel elements between the stowed configuration and the deployed configuration.

In at least some examples, said panel elements are in the form of solar panels.

Additionally or alternatively, for example, at least one said panel element is pivotably mounted to a structure. For example, said structure is a space vehicle.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is an isometric view of a panel system according to an example of the presently disclosed subject matter, and in which the panel system is in a stowed configuration.

FIG. 2 is an isometric view of the panel system example of FIG. 1, in the deployed configuration.

FIG. 3 is a first example of an actuator comprised in the panel system example of FIG. 1.

FIG. 4 illustrates in unfolded partial view an example of an outer cylinder and an actuation portion of the actuator example of FIG. 3.

FIG. 5 illustrates in unfolded partial view another example of an outer cylinder of the actuator example of FIG. 3.

FIG. 6 illustrates in unfolded partial view another example of an outer cylinder of the actuator example of FIG. 3.

FIG. 7 schematically illustrates in unfolded partial view respective examples of an outer cylinder and an actuation portion of a plurality of actuators of the example of FIG. 3 comprised in the panel system example of FIG. 1.

FIG. 8 is an isometric view of a panel system according to a second example of an actuator comprised in the panel system example of FIG. 1.

FIG. 9 is an isometric view of a panel system according to a third example of an actuator comprised in the panel system example of FIG. 1.

FIG. 10(a) schematically illustrates an alternative variation of the panel system example of FIG. 1; FIG. 10(b) schematically illustrates another alternative variation of the panel system example of FIG. 1.

FIG. 11(a) schematically illustrates an alternative variation of the panel system example of FIG. 1 in stowed configuration; FIG. 11(b) schematically the example of FIG. 1 in deployed configuration.

### DETAILED DESCRIPTION

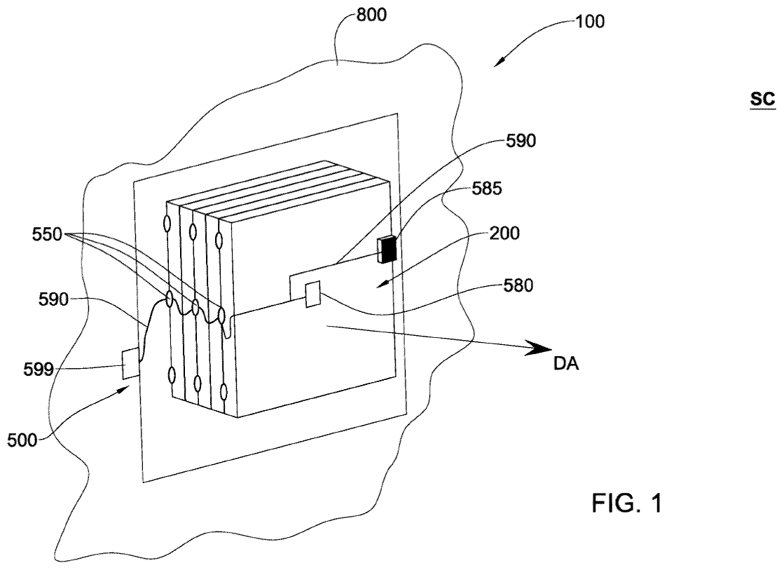

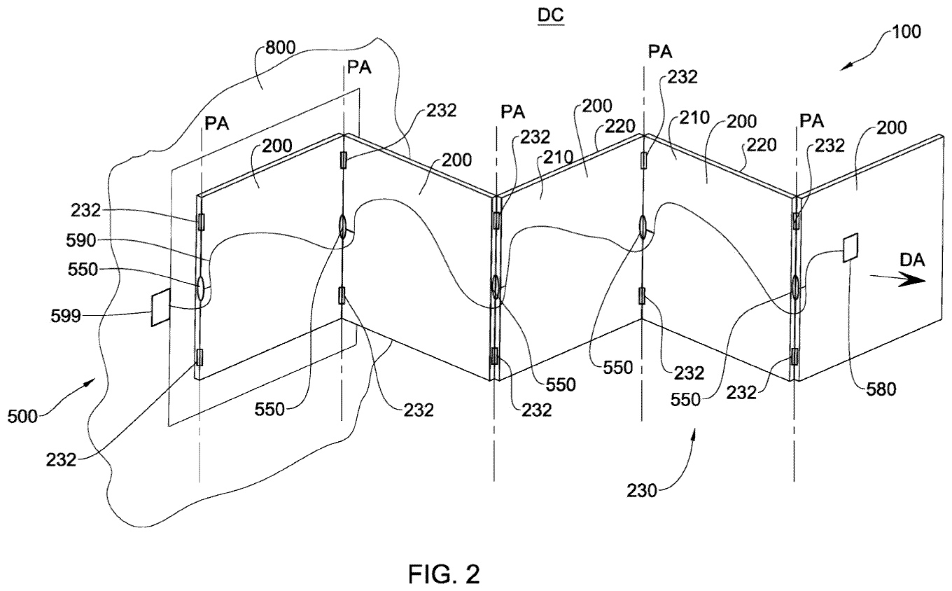

Referring to FIGS. 1 and 2, a panel system according to a first example of the presently disclosed subject matter, generally designated 100, comprises a first plurality of panel elements 200, and a deployment system 500.

In at least this example, the panel system 100 is configured to be mounted to a structure 800, which in at least this example is in the form of a space vehicle, and the panel elements 200 are solar panels configured for generating electrical power. For example, the space vehicle can be a satellite, space station, ground vehicle, manned or unmanned space vehicle, or indeed a static space structure such as for example a base on the moon, and asteroid or other space body. However, in alternative variations of this example, the panel system 100 can instead be mounted to any other suitable structure, for example in environments in which effects of gravity are not significant, for example underwater, and/or, the panel elements can instead be antenna elements, mechanical grappling elements, and so on.

The deployment system 500 is configured for deploying the plurality of panel elements 200 between a stowed configuration SC and a deployed configuration DC. In at least this example, the deployment system 500 is configured for deploying the plurality of panel elements 200 from the stowed configuration SC to the deployed configuration DC, and optionally to an intermediate partially deployed configuration, and also for deploying the plurality of panel elements 200 from the deployed configuration DC to the stowed configuration SC, or to an intermediate partially deployed configuration. However, in at least some alternative variations of this example, the deployment system 500 is configured for non-reversibly deploying the plurality of panel elements 200 from the stowed configuration SC to the deployed configuration DC.

In at least this example, the panel elements 200 are essentially identical to one another, in size and shape, and each panel element 200 is generally planar, having a general rectangular plan form, with opposite facing faces 210, 220. However, in at least some alternative variations of this example, the panel elements can have any suitable shape and/or size, and may be identical to one another or different from one another.

In yet other alternative variations of this example, the panel elements can have a non-flat form, and/or can be hollow. For example, such “panel elements” can refer to any suitable structural components that are pivotably mounted to one another serially, and can be pivoted with respect to one another from a respective stowed configuration and a respective deployed configuration. In some examples, such panel elements can be in the form of strut modules that are stowed together in a compact manner in the respective stowed configuration, and the struct modules pivot outwardly with respect to one another to form a mast or the like when fully pivoted to the deployed configuration.

While in the illustrated example in FIGS. 1 and 2 the panel system 100 is shown as having five panel elements 200 serially disposed with respect to one another, this is for the purpose of illustration only. According to an aspect of the presently disclosed subject matter the aforesaid first plurality of panel elements 200 can include 2, 3, 4, 6 or more than 6 panel elements 200, and furthermore, the panel elements 200 can be pivotably mounted to one another in a variety of ways, not limited to the serially disposed example of FIGS. 1 and 2.

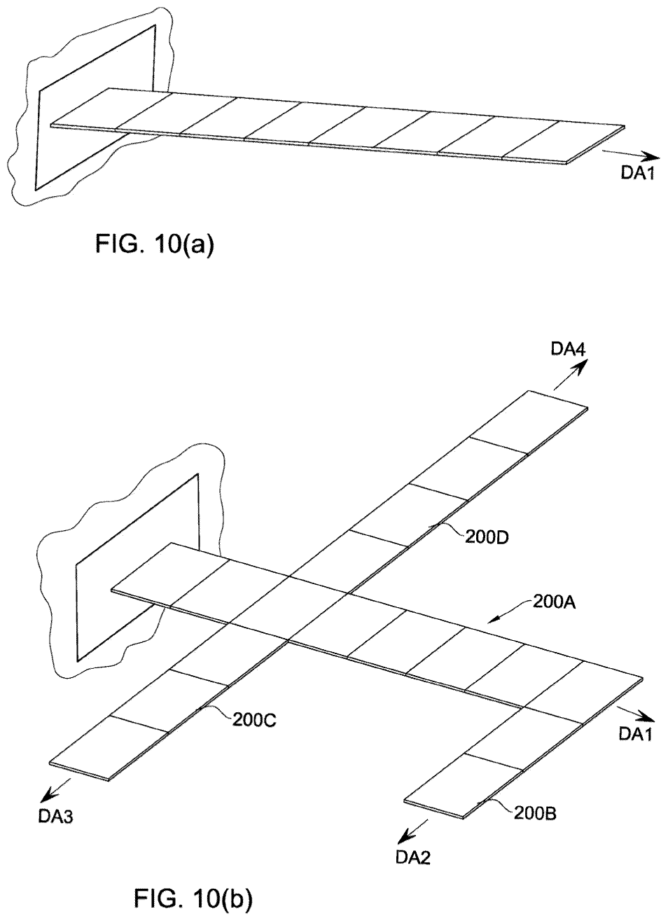

For example, in the example illustrated in FIG. 10(a) there are a plurality of more than five panel elements 200 serially arranged in single file along a single deployment axis DA1.

For example, in the example illustrated in FIG. 10(b) the plurality of panel elements 200 are divided into four sets: in the first set 200A, the respective panel elements 200 are serially arranged in single file along a first deployment axis DA1, while in the other three sets 200B, 200C, 200D the respective panel elements 200 are serially arranged in single file along respective second deployment axis DA2, third deployment axis DA3 and fourth deployment axis DA4. In the example of FIG. 10(b) the second deployment axis DA2, third deployment axis DA3 and fourth deployment axis DA4 are parallel to one another and orthogonal to the first deployment axis DA1, and furthermore all four deployment axes are generally co-planar. However, in alternative variations of this example, the plurality of panel elements can include any number of sets of panel elements, and each set can have a respective deployment axis having any desired suitable orientation with respect to the other sets or their respective deployment axes.

In the examples illustrated in FIGS. 1, 2, 10(a) and 10(b) the actuators of each adjacent pairs of actuators (along the deployment axis DA) are configured for pivoting in mutually opposite directions, such that during deployment between the stowed configuration SC and deployed configuration DC the panel system adopts an accordion-like intermediate configuration.

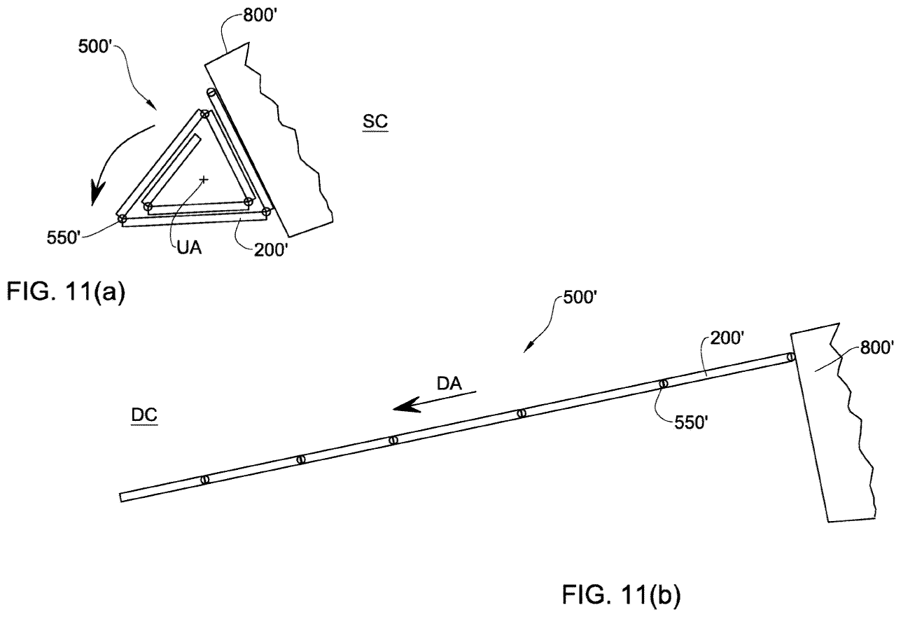

However, in at least some other examples, and referring for example to FIG. 11(a) and FIG. 11(b), adjacent pairs of actuators 550′ (along the deployment axis DA) are configured for pivoting in the same direction, such that during deployment between the respective stowed configuration SC and the respective deployed configuration DC the panel system essentially unrolls about an unrolling axis UA from a generally spiral configuration, for example as illustrated in FIG. 11(a), to a nominally linear configuration, for example as illustrated in FIG. 11(b). In such examples, for example, the width of the respective panel elements 200′ can diminish along the deployment axis DA in a direction away from the respective structure 800′ on the which the respective panel system 500′ is mounted.

Referring again in particular to FIG. 1, in at least this example, in the stowed configuration SC, the panel elements 200 have a compact configuration, for example in which the panel elements 200 are essentially serially superposed over one another, as illustrated in FIG. 1 for example in a zig-zag manner. Thus, in the stowed configuration SC the faces 210, 220 of one panel element are facing and in close proximity to the faces 210, 220 of a respective adjacent panel element.

Referring in particular to FIG. 2, in the deployed configuration DC, the panel elements 200 are deployed along a respective deployment axis DA, as will become clearer herein, to adopt a general planar configuration, in which the panel elements 200 are nominally planar with respect to open another, or at least in a relatively flat open accordion configuration, for example.

In at least this example, the first plurality of panel elements 200 comprises serially adjacent pairs of panel elements 200, and for each such adjacent pair, the respective panel elements 200 are pivotably mounted to one another about a respective pivot axis PA. Accordingly, each such adjacent pair of panel elements 200 comprises a suitable respective hinge arrangement 230, comprising one or more hinges 232 having their pivot axes co-axial with the respective pivot axis PA.

It is to be noted that the innermost panel element 200 of the first plurality of panel elements is also pivotably mounted about a respective pivot axis PA with respect to the structure 800.

The deployment system 500 comprises a second plurality of actuators 550, an actuation cable 590 and a drive unit 599.

In at least this example, one such actuator 550 is associated with each respective pair of said panel elements, and is configured for transitioning the panel elements 200 of the respective adjacent pair between the respective stowed configuration SC and the respective deployed configuration DC, responsive to operation of drive unit 599 via the actuation cable 590.

However, in alternative variations of this example, each respective adjacent pair of panel elements 200 can instead have two or more than two such actuators 550. In such a case, the two or more such actuators 550 are together configured for transitioning the panel elements 200 of the respective adjacent pair of panel elements 200, between the stowed configuration SC and the deployed configuration DC, responsive to operation of drive unit 599 via the actuation cable 590.

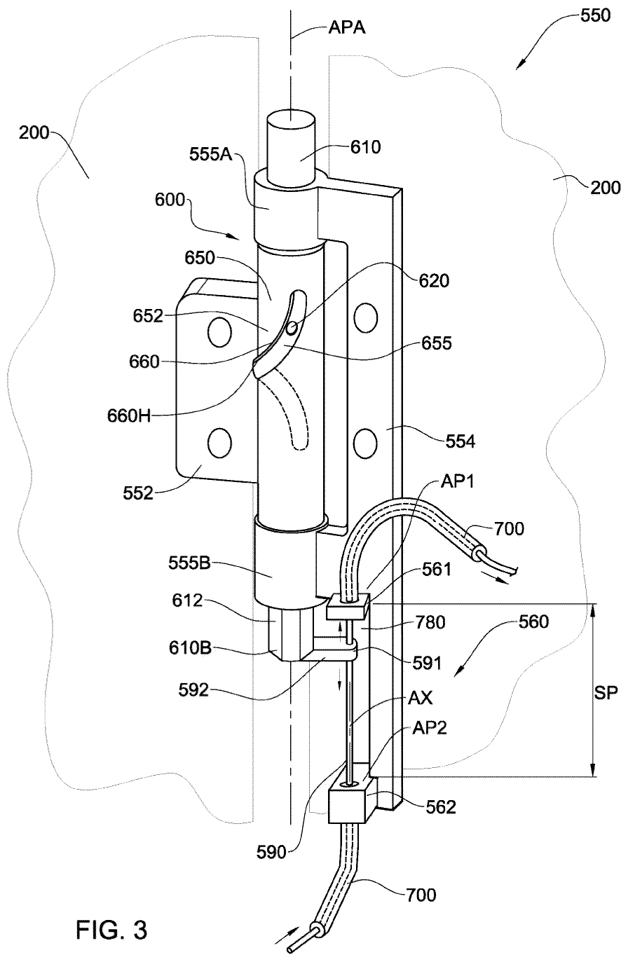

Referring to FIG. 3, a first example of an actuator 550 comprises a first bracket 552, a second bracket 554, and a linear motion to rotary motion converter 600.

The first bracket 552 is configured for being fixedly mounted to one panel element 200 of the respective adjacent pair of panel elements, while the second bracket 554 is configured for being fixedly mounted to the other panel element of the respective adjacent pair of panel elements 200. The first bracket 552 and the second bracket 554 can thus be mounted to the respective panel elements 200 in any suitable manner, for example by bolting, riveting, welding, bonding, and so on. Alternatively, the first bracket 552 and the second bracket 554 can each be integrally formed with the respective panel element 200.

The first bracket 552 and the second bracket 554 are also pivotably mounted with respect to one another about a respective actuator pivot axis APA, which is co-axial with the respective panel element pair pivot axis PA.

As will become clearer herein, the linear motion to rotary motion converter 600 is configured for pivoting the respective first bracket 552 with respect to the respective second bracket 554 responsive to a predetermined datum linear displacement being applied to the linear motion to rotary motion converter 600.

The actuation cable 590 is serially coupled to each one of the actuators 550, in a manner such as to enable applying at least the aforesaid datum linear displacement to the respective linear motion to rotary motion converter 600 of each actuator 550.

The actuation cable 590 is configured for being displaced linearly with respect to the plurality of actuators 550 at least between a first cable position P1 and a second cable position P2, responsive to operation of the drive unit 599. The first position P1 corresponds to the stowed configuration SC, while the second position P2 corresponds to the deployed configuration DC.

The drive unit 599 is configured for selectively displacing the actuation cable 590 at least between the first cable position P1 and the second cable position P2. For example, the drive unit 599 can be in the form of a rotary motor or linear motor, driven by electrical power or by pneumatic pressure or by hydraulic pressure, or can be in the form of a mechanical stored energy device, for example suitable spring arrangement, or can be in the form of a pyrotechnic device coupled to a piston arrangement, and so on.

In at least this example, the linear motion to rotary motion converter 600 comprises a linearly movable shaft element 610 and a rotary element 650.

The linearly movable shaft element 610 is slidably mounted between two ends 555A, 555B of the second bracket 554, allowing relative axial movement between the shaft element 610 and the second bracket along the actuator pivot axis APA.

The linearly movable shaft element 610 is fixedly coupled to the actuation cable 590.

In at least the illustrated example, the second bracket 554 comprises an actuation portion 560, comprising a pair of mechanical tabs 561, 562, fixedly mounted to the second bracket 554, and spaced by an axial spacing SP from one another along an axis AX parallel to the actuator pivot axis APA. The mechanical tabs 561, 562 each have a respective opening 563, and the actuation cable 590 passes through the two openings 563, exposing a length of actuation cable 590 between the two mechanical tabs 561, 562 corresponding to the axial spacing SP. One end 610B of the shaft element 610 projects out of the second end 555B of the second bracket 554, and is fixedly mounted via arm 592 to the actuation cable 590 at a location 591 within the exposed length of actuation cable 590 between the two mechanical tabs 561, 562. The arm 592 can thus be axially displaced between the two mechanical tabs 561, 562 as the actuation cable 590 is concurrently displaced between the two mechanical tabs 561, 562. The two mechanical tabs 561, 562 thus provide axial displacement limits for the actuation cable 590 via the arm 592.

The rotary element 650 is fixedly mounted to the first bracket 552.

Furthermore, the rotary element 650 is operatively coupled to the shaft element 610 such that the rotary element 650 pivots together with the first bracket 552 with respect to the second bracket 554 responsive to the aforesaid datum linear displacement being applied to the shaft element 610.

In at least this example, the rotary element 650 comprises a jacket in the form of an outer cylinder 652 co-axial with and overlying at least part of the shaft element 610. The outer cylinder 652 is fixedly mounted with respect to the first bracket 552. The outer cylinder 652 comprises a cam groove 660 having at least one helical portion 660H. The outer cylinder 652 is also co-axial with the respective actuator pivot axis APA.

As disclosed above, the shaft element 610 is movably mounted with respect to second bracket 554 in an axial direction parallel to, and in at least this example co-axial with, the actuator pivot axis APA. The shaft element 610 is mechanically constrained for enabling axial movement with respect to the second bracket 554, and concurrently prevented from relative rotary movement with respect to the second bracket 554. In at least this example, a first shaft element end portion 612 including end 610B of the shaft element 610 has a non-circular cross-section, for example polygonal. The corresponding second end 555B of the second bracket 554 with respect to which the first shaft element end portion 612 is mounted has an internal cross-section that is complementary to that of the first shaft element end portion 612, thereby enabling relative axial movement of the shaft element 610 with respect to the second end 555B, and thus with respect to the second bracket 554, while concurrently preventing relative rotation of the shaft element 610 with respect to the second end 555B about the actuator pivot axis APA, and thus with respect to the second bracket 554.

In alternative variations of this example, other mechanical arrangements can be provided for constraining relative movement between the shaft element 610 and the second bracket 554 to axial movement while preventing relative rotary movement. For example, one of the shaft element 610 and the second bracket 554 can comprised a radial pin projecting towards the other, and the other one of the shaft element 610 and the second bracket 554 can comprise a complementary channel running along a direction parallel to the actuator picot axis APA, in which the pin is received in and is able to slide along the channel.

The shaft element 610 comprises a cam follower 620. In at least this example, the cam follower 620 is in the form of a pin radially projecting from a mid-section 655 of the shaft element 610. The cam follower 620 is coupled to the cam groove 660, such that relative movement between the shaft element 610 and the outer cylinder 652 is determined by the relative movement between the cam follower 620 and the cam groove 660.

Thus, the shape of the cam groove 660 can be designed to provide the desired relative movement between the shaft element 610 and the outer cylinder 652 responsive to an axial displacement of the shaft element 610 with respect to the outer cylinder 652.

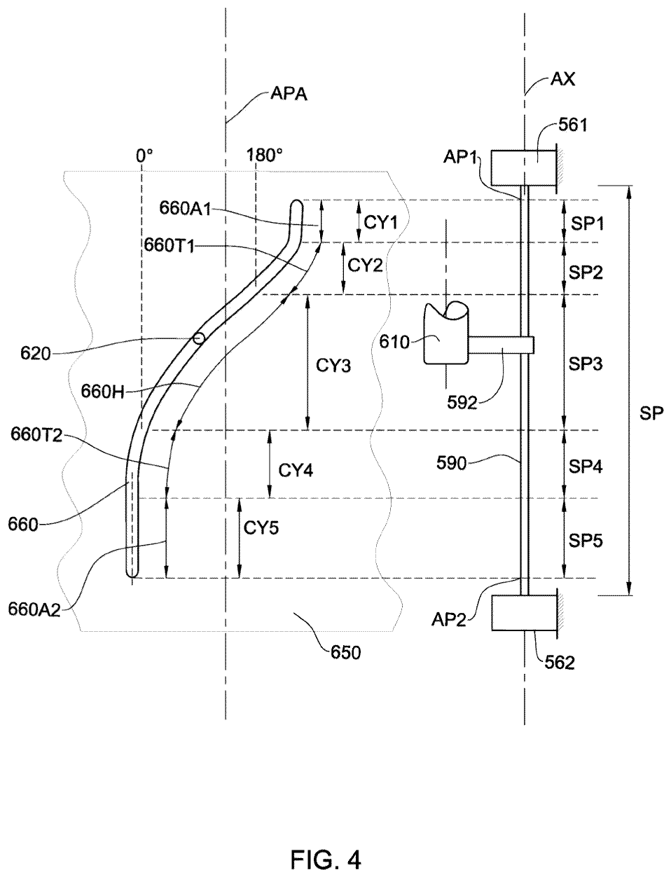

FIG. 4 illustrates the outer cylinder 652 unfolded into a flat sheet, and compares (a) the movement of the cam follower 620 with respect to the cam groove 660, with (b) the concurrent axial movement of the arm 592 with respect to the spacing SP.

In the example illustrated in FIG. 4, the cam groove 660 comprises:
the aforesaid helical portion 660H, located generally centrally;
a first linear portion 660A1 located at a top end of the cam groove 660;
a first tapering portion 660T1 smoothly connecting the first linear portion 660A1 with one end of the helical portion 660H;
a second linear portion 660A2 located at a bottom end of the cam groove 660;
a second tapering portion 660T2 smoothly connecting the second linear portion 660A2 with the other end of the helical portion 660H.

Each one of the first linear portion 660A1, the first tapering portion 660T1, the helical portion 660H, the second tapering portion 660T2, and the second linear portion 660A2 has a respective axial dimension CY1, CY2, CY3, CY4, CY5, respectively, corresponding to respective axial displacement zones within the spacing SP: SP1, SP2, SP3, SP4, SP5, respectively.

Since the arm 592, shaft element 610 and cam follower 620 move as a rigid body, any axial displacement of the arm 592 within the spacing SP results in the same axial displacement of the cam follower 620 with respect to the cam groove 660.

Thus, when the arm 592 is in axial displacement zone SP1 or in axial displacement zone SP5, the cam follower 620 is in first linear portion 660A1 or second linear portion A2, respectively. Thus, axial displacement of the arm 592 within the first axial displacement zone SP1 causes the cam follower 620 to correspondingly move with respect to the first linear portion 660A1, while axial displacement of the arm 592 within the fifth axial displacement zone SP5 causes the cam follower 620 to correspondingly move with respect to the second linear portion 660A2. However, since the first linear portion 660A1 and the second linear portion A2 are each parallel to the actuator pivot axis APA, such axial displacements do not result in any relative rotation between the cylinder 650 and the shaft element 610, and thus there is no pivoting between the first bracket 552 and the second bracket 554.

The first linear portion 660A1 and the second linear portion 660A2 provide position tolerance for the cam follower 620.

It is further to be noted that the first linear portion 660A1 and the second linear portion 660A2 each provide a locking effect when the respective cam follower 620 is located therein, since any external rotational force applied to the cylinder 650 is resisted by the cam follower 620, preventing pivoting.

Furthermore, the respective axial dimension CY1, CY5 of the first linear portion 660A1 and the second linear portion 660A2, respectively, can be chosen such as to provide a desired delay of the onset of pivoting (corresponding to the cam follower 620 being in the helical portion 660H) with respect to the axial displacement of the arm 592.

When the arm 592 is in the central, third axial displacement zone SP3, the cam follower 620 is in the helical portion 660H, and thus, axial displacement of the arm 592 within the third axial displacement zone SP3 causes the cam follower 620 to correspondingly move with respect to the helical portion 660H. The helical geometry of the helical portion 660H ensures that any relative axial movement between the cam follower 620 and the cam groove 660 results in a corresponding and concurrent rotational movement between the cylinder 650 and the shaft element 610, which in turn causes corresponding pivoting between the first bracket 552 and the second bracket 554 about the actuator pivot axis APA. It is to be noted that at least in this example, the third axial displacement zone SP3 corresponds to the aforesaid datum linear displacement.

In at least this example, the helical portion 660H corresponds to a half helix turn, and thus the first bracket 552 and the second bracket 554 pivot with respect to one another by a pivot angle of 180°, thereby enabling the respective adjacent pair of panel elements 200 mounted to the first bracket 552 and the second bracket 554 to pivot 180° about the actuator pivot axis APA from the stowed configuration SC to a flat and open (coplanar) deployed configuration DC.

In the unfolded view provided in FIG. 4, the contour of the helical portion 660H appears as a sinusoidal groove, of half period corresponding to the half helix turn.

However, the helical portion 660H can have any desired proportion of a full helix turn, and this will result in a corresponding pivoting angle between the first bracket 552 and the second bracket 554. For example, if the helical portion 660H corresponds to any one of ¼, ⅓, ⅙ helix turn, the corresponding pivoting angle will be 90°, 120°, 60°, respectively.

It is also to be noted that the helical portion 660H also has a corresponding helix pitch, which in this example (in which the helical portion 660H corresponds to a half helix turn) is 2*CY3. The magnitude of the helix pitch determines the pivoting rate of the pivoting between the first bracket 552 and the second bracket 554, with respect to linear displacement rate of the arm 592. The smaller the helix pitch, the larger the corresponding pivot angle between the first bracket 552 and the second bracket 554 for a given axial displacement of the arm 592 within the third axial displacement zone SP3. Conversely, the higher the helix pitch, the smaller the corresponding pivot angle between the first bracket 552 and the second bracket 554 for a given axial displacement of the arm 592 within the third axial displacement zone SP3.

The first tapering portion 660T1 provides a smooth geometric transition between the first linear portion 660A1 and the helical portion 660H, and similarly the second tapering portion 660T2 provides a smooth geometric transition between the second linear portion 660A2 and the helical portion 660H. This enables the cam follower 620 to travel the full extent of the cam groove 660, in either direction, with a minimum or absence of jerking.

Thus, in the example of FIG. 4, as the arm 592 is displaced from a first arm position AP1 at or close to first mechanical tab 561 to a second arm position AP2 at or close to second mechanical tab 562 (responsive to the actuator cable 590 being corresponding displaced), serially passing through the respective axial displacement zones within the spacing SP, i.e. spacings SP1, SP2, SP3, SP4, SP5, the cam follower 620 concurrently passes through the first linear portion 660A1, the first tapering portion 660T1, the helical portion 660H, the second tapering portion 660T2, and the second linear portion 660A2, and causing relative pivoting between the first bracket 552 and the second bracket 554 (in at least this example, to provide total pivoting of 180°) while the cam follower 620 is passing through the helical portion 660H.

It is to be noted that the profile of the cam groove 660 can be chosen to provide the desired deployment profile for the respective actuator 550, and thus for the respective adjacent pair of panel elements 200.

It is to be further noted that in at least some examples, each one of the first linear portion 660A1, the first tapering portion 660T1, the second linear portion 660A2 and the second tapering portion 660T2 are optional, and the profile of the cam groove 660 can be chosen to include only the helical portion 660H, or the helical portion 660H plus any combination of the first linear portion 660A1, the first tapering portion 660T1, the second linear portion 660A2 and the second tapering portion 660T2.

For example, in at least some examples, the profile of the cam groove 660 can be chosen to include only the helical portion 660H, and thus omits the first linear portion 600A1, the first tapering portion 660T1, the second linear portion 660A2 and the second tapering portion 660T2.

For example, in at least some other examples, the profile of the cam groove 660 can be chosen to include the helical portion 660H plus one or both of the first linear portion 660A1 and the second linear portion 660A2, and thus omits the first tapering portion 660T1 and the second tapering portion 660T2.

For example, in at least some other examples, the profile of the cam groove 660 can be chosen to include the helical portion 660H plus one or both of first tapering portion 660T1 and the second tapering portion 660T2, and thus omits the first linear portion 660A1 and the second linear portion 660A2.

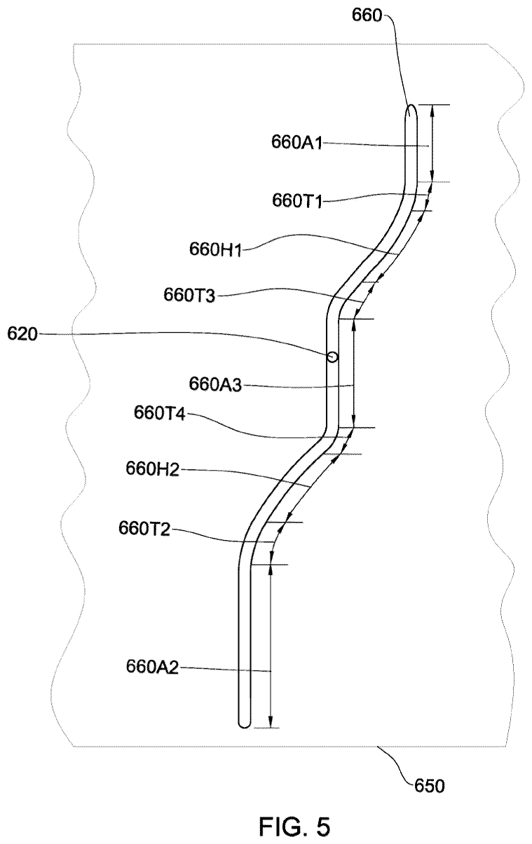

For example, FIG. 5 illustrates the outer cylinder 652 unfolded into a flat sheet, and provides an alternative example for the profile for the respective cam groove 660. In this example, the respective cam groove 660 comprises:
a first linear portion 660A1 located at a top end of the cam groove 660;
a first helical portion 660H1, smoothly connected to the first linear portion 660A1 via a first tapering portion 660T1;
a second linear portion 660A2 located at a bottom end of the cam groove 660;
a second helical portion 660H2, smoothly connected to the second linear portion 660A2 via a second tapering portion 660T2;
a centrally disposed third linear portion 660A3, smoothly connected to the first helical portion 660H1 via a third tapering portion 660T3, and smoothly connected to the second helical portion 660H2 via a fourth tapering portion 660T3.

The first helical portion 660H1 and the second helical portion 660H2 are in the same rotational direction, for example both are right-handed or both are left-handed.

Thus, as the corresponding arm 592 is displaced from a first arm position AP1 at or close to first mechanical tab 561 to a second arm position AP2 at or close to second mechanical tab 562 (responsive to the actuator cable 590 being corresponding displaced), serially passing through the respective axial displacement zones within the spacing SP, the cam follower 620 concurrently passes through the first linear portion 660A1, the first tapering portion 660T1, the first helical portion 660H1, the third tapering portion 660T3, the third axial portion 660A3, the fourth tapering portion 660T4, the second helical portion 660H2, the second tapering portion 660T2, and the second linear portion 660A2. This motion causes pivoting between the first bracket 552 and the second bracket 554 while the cam follower 620 is passing through the first helical portion 660H1 and while passing through the second helical portion 660H2, while stopping pivoting while the cam follower 620 is passing through the third axial portion 660A3.

In other words, full pivoting between the first bracket 552 and the second bracket 554 is carried out in two stages, with a break in-between, and this can be useful in situations for example in which, once the actuator 550 has finished pivoting re the first helical portion 660H1, it is necessary to prevent interfering with another panel element or other equipment that is also deploying, and once cleared the panel elements 200 can continue to deploy to its final position via the second helical portion 660H2 of the actuator 550.

For example, the combination of the first helical portion 660H1 and the second helical portion 660H2 corresponds to a half helix turn, and thus the first bracket 552 and the second bracket 554 pivot with respect to one another by a total pivot angle of 180°, thereby enabling the respective adjacent pair of panel elements 200 mounted to the first bracket 552 and the second bracket 554 to pivot 180° from the stowed configuration SC to a flat and open (coplanar) deployed configuration DC, though in two stages.

For example, the first helical portion 660H1 and the second helical portion 660H2 are equal in magnitude and direction. For example, the first helical portion 660H1 and the second helical portion 660H2 each correspond to ¼ helix turn. Thus, the first bracket 552 and the second bracket 554 pivot with respect to one another by a pivot angle of 90° corresponding to the first helical portion 660H1, and subsequently the first bracket 552 and the second bracket 554 pivot with respect to one another by another pivot angle of 90° corresponding to the second helical portion 660H2.

In another variation of this example, the first helical portion 660H1 and the second helical portion 660H2 are not equal in magnitude. For example, the first helical portion 660H1 corresponds to ⅙ helix turn, while the second helical portion 660H2 corresponds to 2/6 helix turn. Thus, the first bracket 552 and the second bracket 554 pivot with respect to one another by a pivot angle of 60° corresponding to the first helical portion 660H1, and subsequently the first bracket 552 and the second bracket 554 pivot with respect to one another by another pivot angle of 120° corresponding to the second helical portion 660H2.

It is to be noted that the full pivot angle of any one of the examples herein is not required to be 180°, and can be any desired angle, for example 90°, 120°, 270°, or any other pivot angle up to just under 360°.

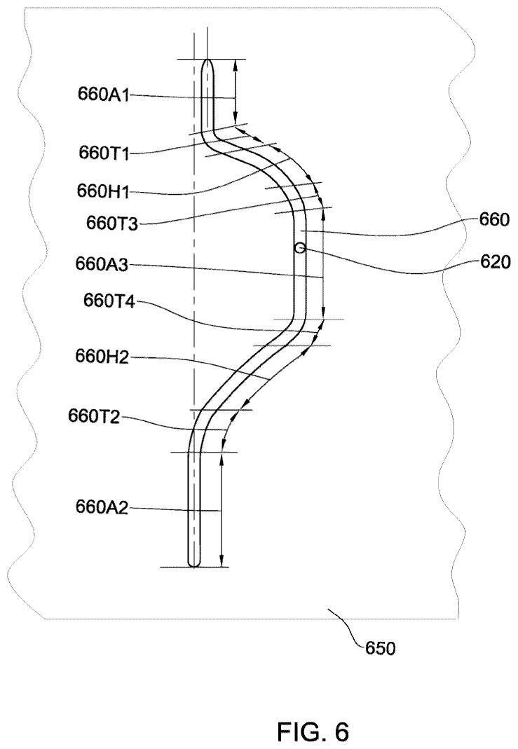

For example, FIG. 6 illustrates the outer cylinder 652 unfolded into a flat sheet, and provides another alternative example for the profile for the respective cam groove 660. In this example, the respective cam groove 660 comprises:
a first linear portion 660A1 located at a top end of the cam groove 660;
a first helical portion 660H1, smoothly connected to the first linear portion 660A1 via a first tapering portion 660T1;
a second linear portion 660A2 located at a bottom end of the cam groove 660;
a second helical portion 660H2, smoothly connected to the second linear portion 660A2 via a second tapering portion 660T2;
a centrally disposed third linear portion 660A3, smoothly connected to the first helical portion 660H1 via a third tapering portion 660T3, and smoothly connected to the second helical portion 660H2 via a fourth tapering portion 660T3.

The first helical portion 660H1 and the second helical portion 660H2 are in opposite rotational directions, for example one is right-handed and the other is left-handed.

Thus, as the corresponding arm 592 is displaced from a first arm position AP1 at or close to first mechanical tab 561 to a second arm position AP2 at or close to second mechanical tab 562 (responsive to the actuator cable 590 being corresponding displaced), serially passing through the respective axial displacement zones within the spacing SP, the cam follower 620 concurrently passes through the first linear portion 660A1, the first tapering portion 660T1, the first helical portion 660H1, the third tapering portion 660T3, the third axial portion 660A3, the fourth tapering portion 660T4, the second helical portion 660H2, the second tapering portion 660T2, and the second linear portion 660A2. This motion causes pivoting between the first bracket 552 and the second bracket 554 while the cam follower 620 is passing through the first helical portion 660H1 and while passing through the second helical portion 660H2, while stopping pivoting while the cam follower 620 is passing through the third axial portion 660A3.

In other words, the first bracket 552 and the second bracket 554 first pivot in one direction (for example to open, from the stowed configuration SC to the deployed configuration DC), and then the first bracket 552 and the second bracket 554 can pivot back in the opposite direction (for example to close, from the deployed configuration DC to the stowed configuration SC), with a break in-between. This configuration can be useful in situations for example in which it is desired to both deploy and subsequently stow the panel elements 200, and in which the drive unit 599 and actuator cable 590 can only operate in one direction (for example in tension but not in compression).

For example, each one of the first helical portion 660H1 and the second helical portion 660H2 corresponds to a half helix turn, and thus the first bracket 552 and the second bracket 554 pivot with respect to one another by a pivot angle of 180°, and then by a pivot angle of −180°. This enables the respective adjacent pair of panel elements 200 mounted to the first bracket 552 and the second bracket 554 to pivot 180° from the stowed configuration SC to a flat and open (coplanar) deployed configuration DC, and then back from the deployed configuration DC to the stowed configuration SC.

However, in at least one alternative variation of this example, the first helical portion 660H1 and the second helical portion 660H2 are not equal in magnitude. For example, the first helical portion 660H1 corresponds to ½ helix turn in one direction, while the second helical portion 660H2 corresponds to ¼ helix turn in the opposite direction. Thus, the first bracket 552 and the second bracket 554 pivot with respect to one another by a pivot angle of 180° in one direction, corresponding to the first helical portion 660H1, and subsequently the first bracket 552 and the second bracket 554 pivot with respect to one another by another pivot angle of 90° in the opposite direction corresponding to the second helical portion 660H2.

In another example, the first helical portion 660H1 corresponds to 4/6 helix turn in one direction, while the second helical portion 660H2 corresponds to ⅙ helix turn in the opposite direction. Thus, the first bracket 552 and the second bracket 554 pivot with respect to one another by a pivot angle of 240° in one direction, corresponding to the first helical portion 660H1, and subsequently the first bracket 552 and the second bracket 554 pivot with respect to one another by another pivot angle of 60° in the opposite direction corresponding to the second helical portion 660H2, thereby leaving the first bracket 552 and the second bracket 554 at a final pivot angle with respect to one another of 180°.

In another example, the first helical portion 660H1 corresponds to ¾ helix turn in one direction, while the second helical portion 660H2 corresponds to ¼ helix turn in the opposite direction. Thus, the first bracket 552 and the second bracket 554 pivot with respect to one another by a pivot angle of 270° in one direction, corresponding to the first helical portion 660H1, and subsequently the first bracket 552 and the second bracket 554 pivot with respect to one another by another pivot angle of −90°, i.e., in the opposite direction, corresponding to the second helical portion 660H2, thereby leaving the first bracket 552 and the second bracket 554 at a final pivot angle with respect to one another of 180°.

Thus, such examples of the configuration as exemplified by FIG. 6 can be useful in examples in which it may be necessary for one panel element 200 to overshoot the respective position corresponding to the final deployed configuration, perhaps to prevent interfering with another panel element or other equipment that is also deploying, and once cleared the panel element 200 can return to its final position.

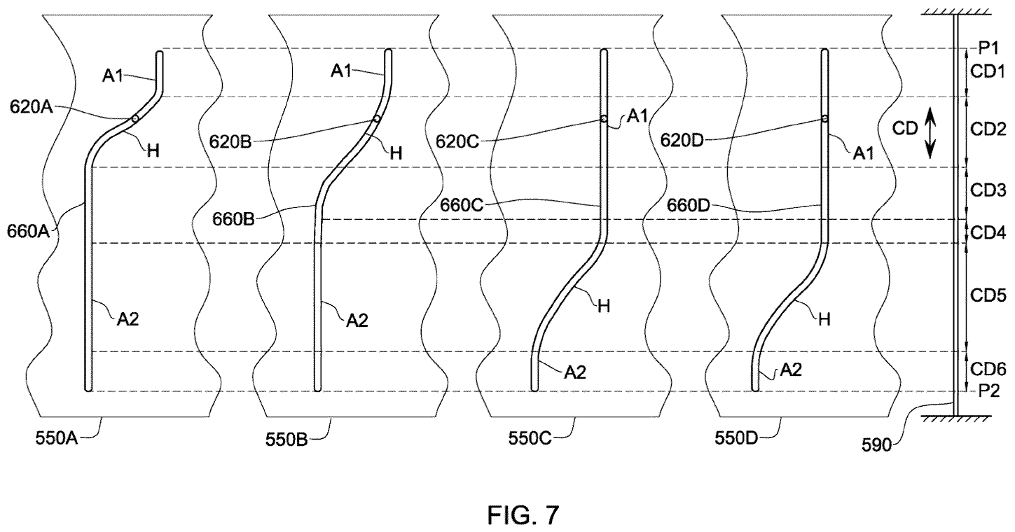

Referring again to FIG. 2, FIG. 3 and FIG. 7, for example, the actuation cable 590 is coupled to all the actuators 550 comprised in the panel system 500. The drive unit 599 is configured for selectively displacing the actuation cable 590 at least between the first cable position P1 and the second cable position P2, corresponding to a cable displacement of CD.

The cable displacement CD is less than or equal to the axial spacing SP of the actuators 550. It is to be noted that while in this example all the actuators 550 are similar or identical to one another, and have the same axial spacing SP with respect to one another, in alternative variations of this example, it is possible for the actuators 550 of the panel system 500 to be different from one another, or to at least have corresponding axial spacing SP that can be different from one another. In cases in which the actuators of the panel system 500 have axial spacing SP different from one another, the cable displacement CD is less than or equal to the axial spacing SP of the actuator 550 having the smallest axial spacing SP.

In any case, the cable displacement CD is at least equal to the spacing between the first arm position and the second arm position of the actuators 550 of the actuator 550 having the smallest axial spacing SP.

As the actuation cable 590 is displaced between the first cable position P1 and the second cable position P2, the arms 592 corresponding to all the actuators 550 are concurrently displaced from the respective first arm positions AP1 to the respective second arm positions AP2, concurrently driving the respective cam followers 620 with respect to the respective cam grooves 660 of the actuators.

In at least the above examples, the actuation cable 590 is enclosed within an envelope 700 comprising a second plurality of windows 780, the envelope 700 being configured for maintaining a predetermined tension in the actuation cable 590. One such window 780 is provided for each actuator 550, and is co-extensive with the actuation portion 560, in particular between the first tab 561 and the second tab 562, thereby exposing the actuation cable 590 between the first tab 561 and the second tab 562.

Referring again to FIG. 2, each actuator 550 is operatively coupled to the actuation cable 590 at a respective window 780, wherein the respective arm 592 is affixed to the cable 590 and is free to move with the actuation cable 590 between the respective first tab 561 and the respective second tab 562.

Such a predetermined tension ensures that any displacement of the actuation cable 590 at the end thereof coupled to the drive unit 599 is concurrently transmitted and reproduced at each actuation portion 560.

It can be readily appreciated that the actuators 550 of the second plurality of actuators 550 are configured for operating in a synchronized manner with respect to one another, and in particular for pivoting in a synchronized manner with respect to one another, responsive to operation of the drive unit and the actuation cable, since displacement of the actuation cable 590 is transmitted simultaneously to all the actuators 550.

In at least this example, the envelope is in the form of a sheath, in particular in the form of an incompressible sheath having a lumen that allows relative axial movement between the cable and the sheath, but essentially preventing the cable from buckling. For example, the sheath is longitudinally incompressible, and in at least some examples can be in the form of a Bowden cable. Such a sheath is fixedly attached at the outer facing ends of each respective pair of first tab 561 and second tab 562.

In alternative variations of this example, such an envelope can be integrated within the panel elements 200, and for example can be in the form of suitable incompressible channels or lumens provided in the panel elements 200.

As disclosed above, in at least the illustrated examples, the deployment system 500 is configured for reversibly deploying the plurality of panel elements 200 between the stowed configuration SC and the deployed configuration DC. For example, the deployment system 500 is configured for deploying the plurality of panel elements 200 from the stowed configuration SC to the deployed configuration DC, and also for deploying the plurality of panel elements 200 from the deployed configuration DC to the stowed configuration SC, or to an intermediate partially deployed configuration. In such cases, and referring again to FIG. 2, the deployment system 500 can further comprise a tensioning arrangement 580 coupled to the actuation cable 590. The tensioning arrangement 580 provides a tensile force to the actuation cable 590 regardless of which direction the actuation cable 590 is being displaced. For example, when the actuation cable 590 is being pulled in one direction towards the drive unit 599, this of itself provides a tension in the actuation cable 590 and the tensioning arrangement 580 may not be required. However, when the actuation cable 590 is being pushed in the opposite direction away from the drive unit 599, the tensioning arrangement 580 provides the required tension in the actuation cable 590 to enable displacement of the actuation cable 590 at the drive unit end to be reproduced at each actuator 550. For example, the tensioning arrangement 580 can be in the form of a pre-stressed spring, anchored at one end to one of the panels, and coupled at another end of the spring to the actuation cable 590.

At least in the example of FIG. 2, all the actuators 550 of the second plurality of actuators 550 are configured for pivoting simultaneously responsive to a predetermined linear displacement being applied to each one of the respective linear motion to rotary motion converters 600. Also in at least this example, all the actuators 550 of the second plurality of actuators 550 are configured for pivoting at the same pivoting rate responsive to a predetermined linear displacement rate being applied to all the respective linear motion to rotary motion converters 600.

As such, all the actuators 550 have the same cam groove configuration for the respective cam grooves 660. In other words, the shape and size of the respective cam grooves 660 are the same for all the actuators 550.

Thus, as the actuation cable 590 is displaced from the first cable position P1 through to the second cable position P2, the respective arms 592 of all the actuators are concurrently displaced from the respective first arm positions AP1 to the respective second arm positions AP2, simultaneously pivoting each adjacent pair of panel elements from the respective stowed configuration SC to the deployed configuration DC. Similarly, actuation of the drive unit 599 in the opposite direction such as to displace the actuation cable from the second cable position P2 to the first cable position P1 causes all the actuators 550 to unfold the panel elements 200 simultaneously from the deployed configuration DC to the stowed configuration SC.

However, in alternative variations of this example, the actuators 550 of the second plurality of actuators 550 can instead be configured for pivoting non-simultaneously with respect to one another, responsive to a predetermined linear displacement being applied simultaneously to all the respective linear motion to rotary motion converters 600, and/or, at least some of the actuators 550 of the second plurality of actuators 550 are configured for pivoting at respective pivoting rates that are different with respect to one another, responsive to a predetermined linear displacement rate being applied simultaneously to all the respective linear motion to rotary motion converters 600. Thus, for example, the drive unit 599 can be operated to displace the actuation cable 590 at a constant displacement rate, and this can cause the actuators 550 to pivot at respective pivoting rates that are different with respect to one another, thereby causing the respective panels 200 to transit between the respective stowed configurations SC and the respective deployed configurations DC at relatively different rates with respect to one another.

For example, it may be desired that one set of the panel elements 200 are to concurrently fully deploy from the respective stowed configuration SC to the deployed configuration DC, while another set of the panel elements 200 are to delay their respective deployment.

By way of example, and referring to FIG. 7, only four actuators 550 of the second plurality of actuators 550 are illustrated, for the sake of simplification, in which the actuation cable 590 is operatively connected to the respective linear motion to rotary motion converters 600. The four actuators 550—individually referred to as actuators 550A, 550B, 550C, 550D—have respective cylinders 650A, 650B, 650C, 650D, each having its respective cam groove 660A, 660B, 660C, 660D, coupled to the respective cam followers 620A, 620B, 620C, 620D.

Also for the sake of simplification, each respective cam groove 660A, 660B, 660C, 660D is shown having a first linear portion A1, a helical portion H, and a second linear portion A2. However, each respective cam groove 660A, 660B, 660C, 660D can optionally also have transition portions between each respective first linear portion A1 and helical portion H, and between respective helical portion and the second linear portion A2

The respective first linear portions A1 of the first cam groove 660A and the second cam groove 660B are of the same axial length, and are significantly shorter than the lengths of the respective first linear portions A1 of the third cam groove 660C and the fourth cam groove 660D.

The respective helical portion H of the second cam groove 660B is axially longer than the respective helical portion H of the first cam groove 660A; the respective second linear portion A2 of the second cam groove 660B is correspondingly axially shorter than the respective first linear portion A1 of the first cam groove 660A.

In at least this example, the third cam groove 660C and the fourth cam groove 660D are identical. The respective first linear portions A1 of the third cam groove 660C and the fourth cam groove 660D are longer than the respective first linear portions A1 of the first cam groove 660A and the second cam groove 660B. In at least this example, the respective first linear portions A1 of the third cam groove 660C and the fourth cam groove 660D are longer than the combination of the respective first linear portion A1 and helical portion H of the first cam groove 660A or of the second cam groove 660B.

The respective second linear portions A2 of the third cam groove 660C and the fourth cam groove 660D are shorter than the respective second linear portions A2 of the first cam groove 660A and the second cam groove 660B. In at least this example, the respective first linear portions A1 of the first cam groove 660A and the second cam groove 660B are each longer than the combination of the respective second linear portion A2 and helical portion H of the third cam groove 660C or of the fourth cam groove 660D.

The respective arms (not shown in this figure) of the respective actuators 550A, 550B, 550C, 550D are fixedly connected to the actuation cable 590 such that when the actuation cable is at the first cable position P1, the respective cam followers 620A, 620B, 620C, 620D are each located at the uppermost end of the respective cam groove 660A, 660B, 660C, 660D (as seen in FIG. 7).

As the actuation cable 590 is displaced from the first cable position P1 towards the second cable position P2, under the action of the drive unit 599, all four cam followers 620A, 620B, 620C, 620D are concurrently displaced by the same displacement.

As the actuation cable 590 is displaced from the first cable position P1 towards the second cable position P2 by a first cable displacement CD1, all four cam followers 620A, 620B, 620C, 620D are concurrently displaced axially by the same displacement CD1, and are located, at the end of the displacement, still in the respective first linear portion A1 of the respective cam groove 660A, 660B, 660C, 660D. Accordingly, during this displacement, there is no relative rotation between the respective first bracket and second bracket of any of the four actuators 550A, 550B, 550C, 550D, and the respective panel elements 200 remain effectively in the stowed configuration SC.

As the actuation cable 590 is displaced further towards the second cable position P2 by a second cable displacement CD2, all four cam followers 620A, 620B, 620C, 620D are concurrently displaced axially by the same displacement CD2. During the course of the second cable displacement CD2, the first cam follower 620A completes passage with respect to the respective helical portion H of the first cam groove 660A, and thus the two respective panel elements 200 mounted to the first actuator 550A are fully deployed from the respective stowed configuration SC to the respective deployed configuration DC. Concurrently, the second cam follower 620B travels along a first part of the respective helical portion H of the second cam groove 660B, and thus the two respective panel elements 200 mounted to the second actuator 550B are only partially deployed from the respective stowed configuration SC to the respective deployed configuration DC. Concurrently, the third cam follower 620C and the fourth cam follower 620D are still within the respective first linear portions A1 of the respective third cam groove 660C and fourth cam groove 660D, and thus the two respective panel elements 200 mounted to the third and fourth actuators 550C, 550D remain in the respective stowed configuration SC.

As the actuation cable 590 continues to be displaced further towards the second cable position P2 by a third cable displacement CD3, all four cam followers 620A, 620B, 620C, 620D are concurrently displaced axially by the same displacement CD3. During the course of the third cable displacement CD3, the first cam follower 620A is now in the respective second linear portion A2 of the first cam groove 660A, and thus the two respective panel elements 200 mounted to the first actuator 550A are effectively locked in the respective deployed configuration DC. Concurrently, the second cam follower 620B completes its passage with respect to the respective helical portion H of the second cam groove 660B, and thus the two respective panel elements 200 mounted to the second actuator 550B are now fully deployed from the previous partially deployed configuration to the respective deployed configuration DC. Concurrently, the third cam follower 620C and the fourth cam follower 620D are still within the respective first linear portions A1 of the respective third cam groove 660C and fourth cam groove 660D, and thus the two respective panel elements 200 mounted to the third actuator 550C, and the two respective panel elements 200 mounted to the fourth actuator 550D remain in the respective stowed configuration SC.

As the actuation cable 590 continues to be displaced further towards the second cable position P2 by a fourth cable displacement CD4, all four cam followers 620A, 620B, 620C, 620D are concurrently displaced axially by the same displacement CD4. The first cam follower 620A and the second cam follower 620B are located, at the end of this displacement, within the respective second linear portions A2 of the first cam groove 660A and second cam groove 660B, respectively. Concurrently, the third cam follower 620C and the fourth cam follower 620D are still located, at the end of this displacement, within the respective first linear portions A1 of the third cam groove 660C and fourth cam groove 660D, respectively. Accordingly, during this fourth cable displacement CD4, there is no relative rotation between the respective first bracket and second bracket of any of the four actuators 550A, 550B, 550C, 550D, and the panel elements 200 remain effectively in the same relative positions as at the end of the third cable displacement CD3.

As the actuation cable 590 continues to be displaced further towards the second cable position P2 by a fifth cable displacement CD5, all four cam followers 620A, 620B, 620C, 620D are concurrently displaced axially by the same displacement CD5. The first cam follower 620A and the second cam follower 620B continue to travel in, and thus are still located, within the respective second linear portions A2 of the first cam groove 660A and second cam groove 660B, respectively. Thus, there is no relative rotation between the respective first bracket and second bracket of first actuator 550A, or between the respective first bracket and second bracket of second actuator 550B Concurrently, the third cam follower 620C completes passage with respect to the helical portion H of the third cam groove 660C, and thus the two respective panel elements 200 mounted to the third actuator 550C are fully deployed from the respective stowed configuration SC to the respective deployed configuration DC. Also concurrently, the fourth cam follower 620D completes passage with respect to the helical portion H of the fourth cam groove 660D, and thus the two respective panel elements 200 mounted to the fourth actuator 550D are fully deployed from the respective stowed configuration SC to the respective deployed configuration DC.

As the actuation cable 590 continues to be displaced further by a sixth cable displacement CD6 to now reach the second cable position P2, all four cam followers 620A, 620B, 620C, 620D are concurrently displaced axially by the same displacement CD6. The four cam followers 620A, 620B, 620C, 620D are located during this displacement and at the end of the displacement, in the respective second linear portion A2 of the respective cam groove 660A, 660B, 660C, 660D. Accordingly, during this displacement, there is no relative rotation between the respective first bracket and second bracket of any of the four actuators 550A, 550B, 550C, 550D, and the panel elements 200 remain effectively in the deployed configuration DC.

Thus, in summary, as the actuation cable 590 is displaced from the first cable position P1 to the second cable position P2, the first actuator 550A and the second actuator 550B simultaneously begin deployment from the respective stowed configurations SC, with the second actuator 550B reaching the respective deployed configuration DC some time after the first actuator 550A has been fully deployed to the respective deployed configuration DC. Up to this point, the third actuator 550C and the fourth actuator 550D remain in the respective stowed configurations SC. Subsequently, as the actuation cable 590 continues to be displaced towards the second cable position P2, the third actuator 550C and the fourth actuator 550D concurrently deploy from the respective stowed configurations SC to the respective deployed configurations DC. After this point, all four actuators 550A, 550B, 550C, 550D are essentially locked in the respective deployed configurations DC, and remain in this condition until the actuation cable 590 reaches the second cable position P2.

While in the above examples each adjacent pair of panel elements has respective hinges 232, independent from the respective actuator(s) 550, in at least some alternative variations of these examples, one, or more than one, or all such hinges 232 can each be replaced with a respective actuator 550, such that each such actuator 550 operates both as a hinge as well as an actuator.

While in the above examples the linear motion to rotary motion converter 600 has been exemplified with respect to a can follower/cam groove arrangement, in at least other examples, the respective linear motion to rotary motion converter can be any suitable mechanical arrangement in which an input in the form of an axial displacement results in a rotary motion output, the input being coupled to the actuation cable while the output is coupled to the adjacent pair of panel elements.

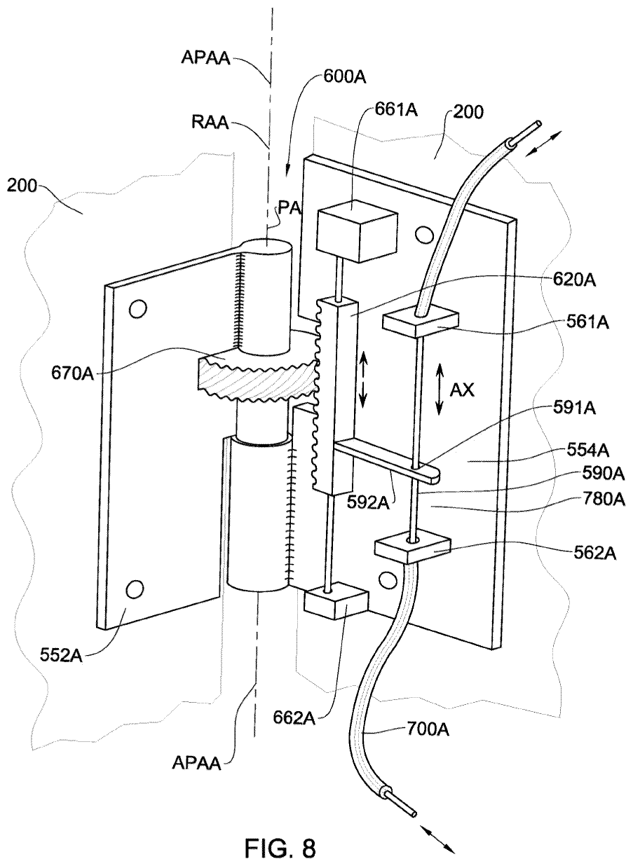

For example, and referring to FIG. 8, a second example of an actuator, designated with reference numeral 550A is similar to actuator 550 as disclosed herein with some differences mutatis mutandis, as will become clearer herein. The actuator 550A comprises a first bracket 552A, a second bracket 554A, and a linear motion to rotary motion converter 600A. The first bracket 552A and the second bracket 554A can be similar to the first bracket 552 and the second bracket 554 as disclosed here, mutatis mutandis. Thus, the first bracket 552A is configured for being fixedly mounted in any suitable manner to one panel element 200 of the respective adjacent pair of panel elements, while the second bracket 554A is configured for being fixedly mounted in any suitable manner to the other panel element of the respective adjacent pair of panel elements 200.

In this example, the linear motion to rotary motion converter 600A is in the form of a rack and pinion arrangement, comprising an axially movable element in the form of a rack element 620A, coupled to a rotary element in the form of a pinion element 670A, such that linear motion of the rack element 620A along an actuation axis AA causes the pinion element 670A to rotate about the rotational axis RAA of the pinion element 670A. In at least this example, the rotational axis RAA of the pinion element 670A is parallel to, and co-axial with, the respective actuator pivot axis APAA. Furthermore, in at least this example, the actuation axis AA is parallel to the rotational axis RAA and to, the respective actuator pivot axis APAA. For example, the rack element 620A is reciprocably linearly movably mounted between two end brackets 661A, 662A, which are fixedly mounted to the second bracket 554A, and spaced by an axial spacing from one another along the actuation axis AA. Thus, the rack element 620A is reciprocably slidable between two end brackets 661A, 662A. Two mechanical tabs 561A, 562A, are fixedly mounted to the second bracket 554A, and spaced by an axial spacing SP from one another along an axis AX parallel to the actuator pivot axis APAA, in a similar manner to the example of FIG. 3, mutatis mutandis.

In a similar manner to the first example, mutatis mutandis, the mechanical tabs 561A, 562A each have a respective opening, and the respective actuation cable 590A passes through the two openings exposing a length of actuation cable 590A between the two mechanical tabs 561A, 562A corresponding to the axial spacing SP.

The rack element 620A is fixedly mounted via arm 592A to the actuation cable 590A at a location 591A within the exposed length of actuation cable 590A between the two mechanical tabs 561A, 562A. The arm 592A can thus be axially displaced between the two mechanical tabs 561A, 562A as the actuation cable 590A is concurrently displaced between the two mechanical tabs 561A, 562A, thereby concurrently displacing the rack element 620A between two end brackets 661A, 662A. The two mechanical tabs 561A, 562A thus provide axial displacement limits for the actuation cable 590A.

The rotary element in the form of pinion element 670A is fixedly mounted to the first bracket 552A. In at least this the pinion element 670A is in the form of a worm gear,

Thus, in operation of the deployment system, as the actuation cable 590A is linearly displaced between mechanical tabs 561A, 562A via the respective drive unit, the rack element 620A is concurrently displaced linearly via the arm 592A, which in turn causes the pinion element 670A to rotate, thereby causing the respective two panel elements 200 to pivot about the respective pivot axis PA.

The magnitude of the displacement of the actuation cable 590A, and thus of the arm 592A, determines the pivoting angle between the first bracket 522A and the second bracket 554A, and thus between the two panel elements 200.

In at least this example, the actuator 550A is configured for reversibly pivoting, such that when the actuation cable 590A is displaced in one direction the first bracket 522A pivots with respect to the second bracket 554A in one direction, while when the actuation cable 590A is displaced in the opposite direction the first bracket 522A pivots with respect to the second bracket 554A in the opposite direction.

In a similar manner to that disclosed herein for the first example illustrated in FIG. 2, mutatis mutandis, in the example of FIG. 8 the actuation cable 590A is enclosed within an envelope 700A comprising a second plurality of windows 780A.

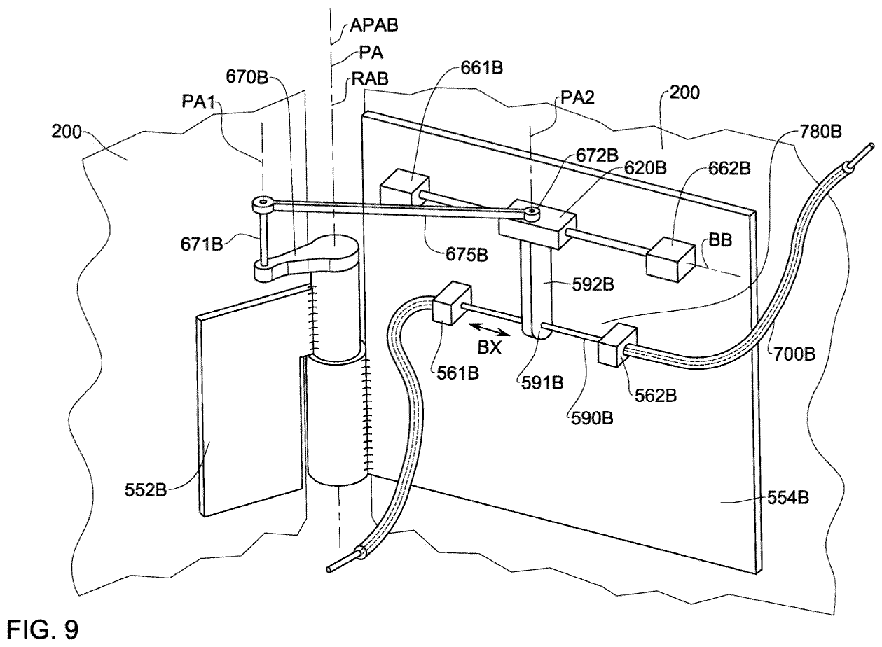

Referring to FIG. 9, a third example of an actuator designated with reference numeral 550B is similar to actuator 550 as disclosed herein with some differences mutatis mutandis, as will become clearer herein. The actuator 550B comprises a first bracket 552B, a second bracket 554B, and a linear motion to rotary motion converter 600B. The first bracket 552B and the second bracket 554B can be similar to the first bracket 552 and the second bracket 554 as disclosed here, mutatis mutandis. Thus, the first bracket 552B is configured for being fixedly mounted in any suitable manner to one panel element 200 of the respective adjacent pair of panel elements, while the second bracket 554B is configured for being fixedly mounted in any suitable manner to the other panel element of the respective adjacent pair of panel elements 200.

In this example, the linear motion to rotary motion converter 600B is in the form of a slider crank arrangement, comprising an axially movable element in the form of a slider element 620B, coupled to a rotary element in the form of a crankshaft element 670B via connecting rod 675B, such that linear motion of the slider element 620B along an actuation axis BB causes the crankshaft element 670B to rotate about the rotational axis RAB of the crankshaft element 670B. In at least this example, the rotational axis RAB of the crankshaft element 670B is parallel to, and co-axial with, the respective actuator pivot axis APAB. Furthermore, in at least this example, the actuation axis BB is orthogonal to the rotational axis RAB and to, the respective actuator pivot axis APAB. For example, the slider element 620B is reciprocably linearly movably mounted between two end brackets 661B, 662B, which are fixedly mounted to the second bracket 554B, and spaced by an axial spacing from one another along the actuation axis BB. Thus, the slider element 620B is reciprocably slidable between two end brackets 661B, 662B. Two mechanical tabs 561B, 562B, are fixedly mounted to the second bracket 554B, and spaced by an axial spacing SP from one another along an axis BX parallel to the actuation axis BB, in a similar manner to the example of FIG. 3, mutatis mutandis.

In a similar manner to the first example, mutatis mutandis, the mechanical tabs 561B, 562B each have a respective opening, and the respective actuation cable 590B passes through the two openings exposing a length of actuation cable 590B between the two mechanical tabs 561B, 562B corresponding to the axial spacing SP.

The slider element 620B is fixedly mounted via arm 592B to the actuation cable 590B at a location 591B within the exposed length of actuation cable 590B between the two mechanical tabs 561B, 562B. The arm 592B can thus be axially displaced between the two mechanical tabs 561B, 562B as the actuation cable 590B is concurrently displaced between the two mechanical tabs 561B, 562B, thereby concurrently displacing the slider element 620B between two end brackets 661B, 662B. The two mechanical tabs 561B, 562B thus provide axial displacement limits for the actuation cable 590B.

The rotary element in the form of crankshaft element 670B is fixedly mounted to the first bracket 552B. In at least this the crankshaft element 670B is in the form of a strut. The connecting rod 675B is pivotably connected to the crankshaft element 670B via a first pin 671B about a first pivot axis PA1. The connecting rod 675B is pivotably connected to the slider element 620B via a second pin 672B about a second pivot axis PA2.

Thus, in operation of the deployment system, as the actuation cable 590B is linearly displaced between mechanical tabs 561B, 562B via the respective drive unit, the slider element 620B is concurrently displaced linearly via the arm 592B, which in turn causes the crankshaft element 670B, via the connecting rod 675B, to pivot about the actuator pivot axis APAB, thereby causing the respective two panel elements 200 to pivot about the respective pivot axis PA.

The magnitude of the displacement of the actuation cable 590B, and thus of the arm 592B, determines the pivoting angle between the first bracket 552B and the second bracket 554B, and thus between the two panel elements 200.

In at least this example, the actuator 550B is configured for reversibly pivoting, such that when the actuation cable 590B is displaced in one direction the first bracket 552B pivots with respect to the second bracket 554B in one direction, while when the actuation cable 590B is displaced in the opposite direction the first bracket 552B pivots with respect to the second bracket 554B in the opposite direction.

In a similar manner to that disclosed herein for the first example illustrated in FIG. 2, mutatis mutandis, in the example of FIG. 9 the actuation cable 590B is enclosed within an envelope 700B comprising a second plurality of windows 780B.

Referring again to FIG. 1, the panel system 100, in particular the deployment system 500, can further comprise a locking arrangement 585, coupled to the actuation cable 590. The locking arrangement 585 is configured for maintaining the plurality of panels 200 locked in the stowed configuration SC at least until the drive unit 599 is activated. For example, the locking arrangement 585 can be configured for transitioning to a respective unlocked mode, in which the locking arrangement 585 is no longer locking the panels 200, responsive to a linear displacement of the actuation cable 590. Thus, at the beginning of displacement of the actuation cable via the drive unit 590, the locking arrangement 585 is first unlocked, and subsequent displacement of the locking arrangement 585 results in pivoting of the panels 200, as disclosed herein for example. For example, such a locking arrangement 585 can be in the form of for example a bolt lock, barrel bolt, latch, and so on.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1-37. (canceled)

38. A deployment system for pivotably deploying a first plurality of panel elements between a stowed configuration and a deployed configuration, wherein adjacent pairs of the first plurality of panel elements are pivotably mounted to one another about a respective panel element pair pivot axis, the deployment system comprising:
a second plurality of actuators;
an actuation cable; and
a drive unit;
wherein:
at least one said actuator is associated with each respective pair of said panel elements, each said actuator comprising a first bracket, a second bracket and a linear motion to rotary motion converter, the first bracket being configured for being fixedly mounted to one panel element of the pair, the second bracket being configured for being fixedly mounted to another panel element of the pair, the respective first bracket and the respective second bracket being pivotably mounted with respect to one another about an actuator pivot axis co-axial with the respective panel element pair pivot axis, and wherein the linear motion to rotary motion converter is configured for pivoting the respective first bracket with respect to the respective second bracket responsive to a predetermined datum linear displacement being applied to the linear motion to rotary motion converter;
the actuation cable being serially coupled to each said actuator of said second plurality of actuators, the actuation cable configured for being displaced linearly with respect to the plurality of actuators at least between a first cable position, corresponding to the stowed configuration, and a second cable position, corresponding to the deployed configuration, responsive to operation of the drive unit, such as to apply at least a corresponding said datum linear displacement to the respective linear motion to rotary motion converter of each said actuator;
the drive unit being configured for selectively displacing the actuation cable at least between the first cable position and the second cable position.

39. The deployment system according to claim 38, wherein each respective said linear motion to rotary motion converter comprises a linearly movable shaft element, coupled to the actuation cable.

40. The deployment system according to claim 39, wherein each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element.

41. The deployment system according to claim 40, wherein the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement.

42. The deployment system according to claim 41, wherein the cam groove comprises at least one linear portion, and wherein application of a second axial displacement of the shaft element relative to the second bracket causes the cam follower to follow at least a portion of said linear portion, preventing the cylinder together with the first bracket from pivoting about the respective pivot axis.

43. The deployment system according to claim 42, wherein the cam groove comprises at least one tapering portion smoothly connecting one said linear portion with one end of one said helical portion.

44. The deployment system according to claim 40, including one of the following:
wherein each respective said linear motion to rotary motion converter is in the form of a rack and pinion arrangement; or
wherein each respective said linear motion to rotary motion converter is in the form of a slider crank arrangement.

45. The deployment system according to claim 38, including one of:
wherein all said actuators of said second plurality of actuators are configured for pivoting simultaneously responsive to a predetermined said datum linear displacement being applied to all the respective linear motion to rotary motion converters; or
wherein all said actuators of said second plurality of actuators are configured for pivoting at the same pivoting rate responsive to a predetermined said datum linear displacement rate being applied to all the respective linear motion to rotary motion converters.

46. The deployment system according to claim 38, including one of the following:
wherein said actuators of said second plurality of actuators are configured for pivoting non-simultaneously with respect to one another, responsive to a predetermined said datum linear displacement being applied simultaneously to all the respective linear motion to rotary motion converters;
wherein at least some said actuators of said second plurality of actuators are configured for pivoting at respective pivoting rates that are different with respect to one another, responsive to a predetermined datum linear displacement rate being applied simultaneously to all the respective linear motion to rotary motion converters;
wherein said actuators of said second plurality of actuators are configured for pivoting in a synchronized manner with respect to one another responsive to operation of the drive unit and the actuation cable; or
wherein the actuation cable is enclosed within an envelope comprising a second plurality of windows, the envelope configured for maintaining a predetermined tension in the actuation cable.

47. The deployment system according to claim 38, wherein the actuation cable is enclosed within an envelope comprising a second plurality of windows, the envelope configured for maintaining a predetermined tension in the actuation cable, and including one of the following:
wherein said envelope is provided by a sheath; or
wherein said envelope is in the form of an incompressible sheath having a lumen that allows relative axial movement between the actuation cable and the sheath.

48. The deployment system according to claim 38, wherein the actuation cable is enclosed within an envelope comprising a second plurality of windows, the envelope configured for maintaining a predetermined tension in the actuation cable, and wherein the envelope is in the form of a Bowden cable.

49. The deployment system according to claim 38, wherein the actuation cable is enclosed within an envelope comprising a second plurality of windows, the envelope configured for maintaining a predetermined tension in the actuation cable, and wherein said envelope is provided by channels provided in the panel elements.

50. The deployment system according to claim 38, wherein the actuation cable is enclosed within an envelope comprising a second plurality of windows, the envelope configured for maintaining a predetermined tension in the actuation cable, and wherein each said actuator is operatively coupled to the actuation cable at a respective said window.

51. The deployment system according to claim 38, further comprising a locking arrangement, coupled to the actuation cable, wherein the locking arrangement is configured for maintaining the plurality of panels elements locked in the stowed configuration at least until the drive unit is activated.

52. A panel system, comprising:
a first plurality of panel elements; and
a deployment system for pivotably deploying the first plurality of panel elements between a stowed configuration and a deployed configuration;
wherein adjacent pairs of the panel elements are pivotably mounted to one another about a respective pivot axis, the deployment system being as defined in claim 38.

53. The panel system according to claim 52, including one of the following:
wherein said panel elements are in the form of solar panels;
wherein at least one said panel element is configured for being pivotably mounted to a structure;
wherein said panel elements are in the form of solar panels, and, wherein at least one said panel element is configured for being pivotably mounted to a structure;
wherein at least one said panel element is configured for being pivotably mounted to a structure, and, wherein said structure is a space vehicle; or
wherein said panel elements are in the form of solar panels, and, wherein at least one said panel element is configured for being pivotably mounted to a structure, and, wherein said structure is a space vehicle.

54. A space vehicle comprising the panel system as defined in claim 52.

55. An actuator for a deployment system, said actuator comprising:
a first bracket;
a second bracket; and
a linear motion to rotary motion converter;
wherein the first bracket being configured for being fixedly mounted to a panel element, the second bracket being configured for being fixedly mounted to another panel element, the respective first bracket and the respective second bracket being pivotably mounted with respect to one another about an actuator pivot axis co-axial with the respective panel element pair pivot axis, and
wherein the linear motion to rotary motion converter is configured for pivoting the respective first bracket with respect to the respective second bracket responsive to a predetermined datum linear displacement being applied to the linear motion to rotary motion converter, and wherein the linear motion to rotary motion converter is configured for being coupled to an actuation cable.

56. The actuator according to claim 55, including one of the following:
wherein each respective said linear motion to rotary motion converter comprises a linearly movable shaft element, configured for being coupled to the actuation cable;
wherein each respective said linear motion to rotary motion converter comprises a linearly movable shaft element, configured for being coupled to the actuation cable, and, wherein each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element;
wherein each respective said linear motion to rotary motion converter comprises a linearly movable shaft element, configured for being coupled to the actuation cable, and, wherein each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element, and, wherein the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement;
wherein each respective said linear motion to rotary motion converter comprises a linearly movable shaft element, configured for being coupled to the actuation cable, and, wherein each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element, and, wherein the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement, and, wherein the cam groove comprises at least one linear portion, and wherein application of a second axial displacement of the shaft element relative to the second bracket causes the cam follower to follow at least a portion of said linear portion, preventing the cylinder together with the first bracket from pivoting about the respective pivot axis; or
wherein each respective said linear motion to rotary motion converter comprises a linearly movable shaft element, configured for being coupled to the actuation cable, and, wherein each respective said linear motion to rotary motion converter comprises a respective rotary element operatively coupled to the shaft element such that the rotary element pivots the respective first bracket with respect to the respective second bracket responsive to a respective said datum linear displacement being applied to the shaft element, and, wherein the rotary element comprises an outer cylinder co-axial with and overlying at least part of the shaft element, the outer cylinder fixedly mounted with respect to the first bracket, the outer cylinder comprising a cam groove having at least one helical portion, and wherein the shaft element is movably mounted with respect to said second bracket, the shaft element being constrained for axial movement with respect to the second bracket and prevented from relative rotary movement with respect to the second bracket, wherein the shaft element comprises a cam follower coupled to the cam groove, and wherein application of a first axial displacement of the shaft element relative to the second bracket causes the cam follower to follow at least a portion of said at least one helical portion, causing the cylinder together with the first bracket to pivot about a corresponding pivot angle about the respective pivot axis, wherein said first displacement corresponds to said datum linear displacement, and, wherein the cam groove comprises at least one linear portion, and wherein application of a second axial displacement of the shaft element relative to the second bracket causes the cam follower to follow at least a portion of said linear portion, preventing the cylinder together with the first bracket from pivoting about the respective pivot axis, and, wherein the cam groove comprises at least one tapering portion smoothly connecting one said linear portion with one end of one said helical portion.

57. A method for deploying a panel system, the method comprising:
providing a first plurality of panel elements and a deployment system for pivotably deploying the first plurality of panel elements between a stowed configuration and a deployed configuration, wherein adjacent pairs of the panel elements are pivotably mounted to one another about a respective pivot axis, the deployment system being as defined in claim 38;
operating the deployment system to cause the panel system to transition the first plurality of panel elements between the stowed configuration and the deployed configuration.

58. The method according to claim 57, including one of the following:
wherein said panel elements are in the form of solar panels;
wherein at least one said panel element is pivotably mounted to a structure;
wherein said panel elements are in the form of solar panels, and, wherein at least one said panel element is pivotably mounted to a structure;
wherein at least one said panel element is pivotably mounted to a structure, and. wherein said structure is a space vehicle; or
wherein said panel elements are in the form of solar panels, and, wherein at least one said panel element is pivotably mounted to a structure, and, wherein said structure is a space vehicle.
